(19) United States
(12) Patent Application Publication
(10) Pub. No.: US 2014/0004265 A1
(43) Pub. Date: Jan. 2, 2014

(54) COPPER COMPLEXES AND THEIR USE AS WOOD PRESERVATIVES

(71) Applicant: E I DU PONT DE NEMOURS AND COMPANY, Wilmington, DE (US)

(72) Inventors: ALBERT GORDON ANDERSON, WILMINGTON, DE (US); MARK A. SCIALDONE, WEST GROVE, PA (US)

(73) Assignee: E I DU PONT DE NEMOURS AND COMPANY, Wilmington, DE (US)

(21) Appl. No.: 14/016,541

(22) Filed: Sep. 3, 2013

Related U.S. Application Data
(62) Division of application No. 12/339,391, filed on Dec. 19, 2008.

(51) Int. Cl. A01N 55/02

(52) U.S. Cl. CPC A01N 55/02
USPC 427/297; 514/499; 427/440; 427/427.7; 427/428.01

(57) ABSTRACT

This invention relates to wood preservatives containing copper complexes that significantly reduce the decay of wood, cellulose, hemicellulose, and lignin caused by fungi and insects. The copper complexes include a chelating compound that has amide functional groups derived from hydration of a cyanoethylated compound or carboxylic acid functional groups derived from hydrolysis of a cyanoethylated compound, or both types of groups.

This application is a divisional of co-pending U.S. application Ser. No. 12/339,391, filed Dec. 9, 2008.

### TECHNICAL FIELD

This invention relates to wood preservatives containing copper complexes that significantly reduce the decay of wood, cellulose, hemicellulose and lignin caused by fungi.

### BACKGROUND

The decay of wood and cellulose by fungi causes significant economic loss. Until recently, the most widely used wood preservative has been chromated copper arsenate (CCA). However, production of CCA for use in residential structures has been prohibited due to issues raised concerning the environmental impact and safety of arsenic and chromium used in CCA-treated lumber. Arsenic-free and chromium-free wood preservatives are sought.

Wood preservation formulations containing copper-chelating molecules are known in the art. One such preservative system is based on a copper complex, Cu—HDO, which contains a bidentate ligand, N-nitrosylated cyclohexyl-hydroxylamine (DE 3,835,370). Another alternative wood preservative is ACQ, an Ammoniacal Copper Quaternary compound as described in U.S. Pat. No. 4,929,454.

Many metal-chelating functionalities are known, causing a central metal ion to be attached by coordination links to two or more nonmetal atoms (ligands) in the same molecule. Heterocyclic rings are formed with the central (metal) atom as part of each ring. Polyhydroxamic acids are known and have been shown to complex with copper. Amidoxime or hydroxamic acids of cyanoethylated cellulose are known as complexation agents for metal ions, including copper (Altas H. Basta, International Journal of Polymeric Materials, 42, 1-26 (1998)) and serve as wood preservatives in U.S. Pat. No. 6,978,724.

Carboxylic acids have been described as components of wood preservatives. In U.S. Pat. No. 4,622,248, wood treated with aliphatic dicarboxylic acids and/or hydroxy mono-, di-, or tricarboxylic acids complexes of Cu, Co, Cd, Ni, and/or Zn with ammonia resisted insects and fungi. In U.S. Pat. No. 6,352,583, the copper complex of tetracarboxylic acid, ethylenediamine-tetraacetic acid (EDTA) is disclosed to preserve wood. EP 781,637 discloses complexing agents that bind di- or trivalent cations that are aminotetracarboxylic acids.

U.S. Pat. No. 6,978,724 (which is by this reference incorporated in its entirety as a part hereof for all purposes) discloses a wood preservative composition that is an aqueous solution of a copper complex of a chelating compound comprising at least two functional groups selected from the group consisting of amidoxime, hydroxamic acid, thiohydroxamic acid, N-hydroxyurea, N-hydroxycarbamate, and N-nitroso-alkyl-hydroxylamine; which is solubilized using ammonia, ethanolamine, or pyridine.

In spite of these and other attempts to develop CCA alternatives, there remains a need for improved wood preservatives.

### SUMMARY

In one embodiment, this invention provides a composition of matter that includes an aqueous solution of (a) a copper complex of a chelating compound comprising multiple amide and/or carboxylic acid groups; and (b) ammonia, ethanolamine or pyridine in an amount sufficient to solubilize the copper complex; wherein the pH of the solution is at least about 9.

In further embodiments of such composition, it may contain zinc ions; the pH may be between about 10 and about 11; the composition may contain multiple amide groups, it may contain multiple carboxylic acid groups, or it may contain multiple amide groups and multiple carboxylic acid groups.

In further embodiments of such composition, an amide group may be a hydration product of a cyanoalkylated compound, and the cyanoalkylated compound may be a cyanoethylated compound. In other embodiments of such composition, a carboxylic acid group may be a hydrolysis product of a cyanoalkylated compound, and the cyanoalkylated compound may be a cyanoethylated compound.

In further embodiments of such composition, the chelating compound may be a cyanoalkylation product of a material selected from the group consisting of monosaccharides, disaccharides, hydrogenated derivatives of monosaccharides, hydrogenated derivatives of disaccharides, and glycerol; and the material may, for example, be sucrose or sorbitol.

In another embodiment, this invention provides a process for preparing a composition of matter by (a) contacting a compound that comprises multiple nitrile groups with water to form a compound comprising multiple amide and/or carboxylic acid groups that forms a complex with copper; (b) combining in aqueous solution copper ions and the compound formed in step (a) to form a complex; and (c) adding to the complex formed in step (b) ammonia, ethanolamine and/or pyridine in sufficient amount to solubilize the complex.

In other embodiments of such a process, the compound that comprises multiple nitrile groups may be a cyanoalkylation product of an alcohol or an amine, such as a cyanoalkylation product of a material selected from the group consisting of monosaccharides, disaccharides, hydrogenated derivatives of monosaccharides, hydrogenated derivatives of disaccharides, and glycerol. Such material may, for example, be sucrose or sorbitol. In other embodiments of such a process, the composition may also contain zinc ions.

In yet another embodiment, this invention provides a process for preserving cellulosic material, or an article that comprises cellulosic material, by contacting the cellulosic material or article with a composition as described above.

In other embodiments of such a process, the cellulosic material may be selected from the group consisting of wood, lumber, plywood, oriented strand board, cellulose, hemicellulose, lignin, cotton and paper; and the process may involve dipping, brushing, spraying, draw-coating, rolling, or pressure-treating the cellulosic material, or article that comprises cellulosic material, with the composition.

In other embodiments of such a process, the cellulosic material, or article that comprises cellulosic material, may be wood or lumber; and the process may further involve subjecting the wood or lumber to vacuum both before and after contacting the wood or lumber with the composition.

In yet another embodiment, this invention provides a process for preserving cellulosic material, or an article that comprises cellulosic material, by contacting the cellulosic material or article with a composition prepared in the manner set forth above.

In yet another embodiment, this invention provides cellulosic material, or an article comprising cellulosic material, wherein a composition as described above, or as prepared in the manner set forth above, is adsorbed on and/or absorbed in the cellulosic material or article.

### DETAILED DESCRIPTION

Applicants have discovered that copper complexes of chelating compounds with one or more amide or carboxylic acid functional group can be prepared and rendered soluble in aqueous solution by the addition of ammonia, ethanolamine, or pyridine. These solubilized copper complexes can subsequently be used to pressure treat wood. Upon loss or evaporation of ammonia, ethanolamine, or pyridine, these copper complexes become insoluble, thereby fixing the copper ions within the wood, where they bind tenaciously to cellulose. In addition applicants have found that including zinc ions in the copper complex composition enhances penetration of the copper complex into the wood. Due to this improved penetration in the presence of zinc ions, lower concentrations of copper preservative agent may be used to achieve adequate internal copper concentrations providing protection, making the wood preservative less costly. Thus the present invention provides more effective and efficient preservatives for cellulosic material.

Cellulosic materials that can be treated with a composition of this invention are those that contain or are derived from cellulose, which is a polysaccharide that forms the main constituent of the cell wall in most plants, and is thus the chief constituent of most plant tissues and fibers. These cellulosic materials include wood and wood products such as lumber, plywood, oriented strand board and paper, in addition to lignin, cotton, hemicellulose and cellulose itself. References herein to the preservation of wood by the use of a composition of this invention, or by the performance of a process of this invention, or references to the usefulness of a composition hereof as a wood preservative, should therefore be understood to be references to the preservation of all types of cellulosic materials, not just wood alone. The treated materials are resistant to fungal attack and are thus preserved.

Suitable chelating compounds for use in this invention have at least one multidentate chelating group that is an amide derived from hydration of a cyanoethylated compound or a carboxylic acid derived from hydrolysis of a cyanoethylated compound. These functional groups can be introduced by the methods described herein or by methods known in the art.

For example, amides can be prepared from cyanoethylated compounds by the hydration (addition of 1 mol of water) of the nitrile-containing compounds. (Eqn. 1)

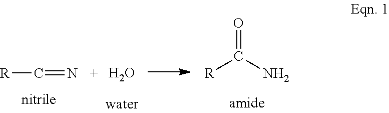

Carboxylic acids can be prepared by the hydrolysis (addition of 2 mols of water and loss of ammonia) of cyanoethylated nitrile-containing compounds with water. (Eqn. 2).

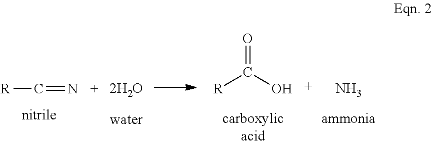

Preferred chelating compounds are those which contain amide and/or non-amino carboxylic acid groups derived from cyanoethylated compounds. The amide functionality can be readily converted to the corresponding carboxylic acid functionality in aqueous solution, a reaction that is catalyzed by either acid or base and is well known to one skilled in the art.

In cyanoethylation (Organic Reactions vol. V, Chapter 2; Wiley; New York; p79-135) acrylonitrile undergoes a conjugate addition reaction with protic nucleophiles such as alcohols and amines (Eqn. 3). Other unsaturated nitriles can also be used in place of acrylonitrile.

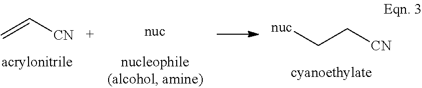

Preferred amines are primary amines and secondary amines having 1 to 30 carbon atoms, and polyethylene amine. Alcohols can be primary, secondary, or tertiary. The cyanoethylation reaction (or “cyanoalkylation” using an unsaturated nitrile other than acrylonitrile) is preferably carried out in the presence of a basic cyanoethylation catalyst. Preferred cyanoethylation catalysts include lithium hydroxide, sodium hydroxide, and potassium hydroxide. The amount of catalyst used is typically between 0.05 mol % and 15 mol %, based on unsaturated nitrile.

A wide variety of materials can be cyanoethylated. Particularly suitable are cyanoethylated compounds obtained from the cyanoethylation of monosaccharides, disaccharides, hydrogenated derivatives of monosaccharides, hydrogenated derivatives of disaccharides, and glycerol. Most suitable are cyanoethylated compounds obtained from the cyanoethylation of sucrose or sorbitol, which are inexpensive and readily available.

The nitrile groups of these cyanoethylates can be reacted with water to form the amide or carboxylic acid and then further reacted with ammoniacal, ethanolamine, or pyridine solutions of copper to give an amide or carboxylic acid copper complex that is a deep blue-colored water-soluble solution.

Nitrile hydration and hydrolysis is carried out by reaction with alkali metal base such as sodium hydroxide, potassium hydroxide, lithium hydroxide, barium hydroxide or ammonium hydroxide. Sodium hydroxide is preferred. The reaction can be monitored by IR spectroscopy, where the loss of the nitrile peak at 2250 cm⁻¹ is indicative of amide or carboxylic acid formation. Since both functional groups form complexes with copper, there is no need to separate the amide and carboxylic acid compounds before formation of the copper complex.

Preparation of the copper complexes of amides or non-amino carboxylic acids is carried out by adding a solution of Cu(II) salts to an aqueous solution of the amide or carboxylic acid. Suitable Cu(II) salts include copper sulfate, copper sulfate pentahydrate, cupric chloride, cupric acetate, and basic copper carbonate. The preferred copper salts are copper acetate and copper sulfate.

Examples of chelating compounds used to form copper complexes in the present process and composition are a hexacarboxylic acid produced by cyanoethylation of sorbitol, shown as Diagram I:

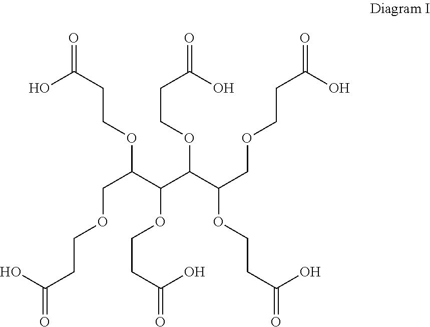 [SMILES: O=C(O)CCOCC(OCCC(=O)O)C(OCCC(=O)O)C(OCCC(=O)O)C(COCCC(=O)O)OCCC(=O)O]

and an amide produced by the hydration of cyanoethylated sorbitol shown as Diagram II:

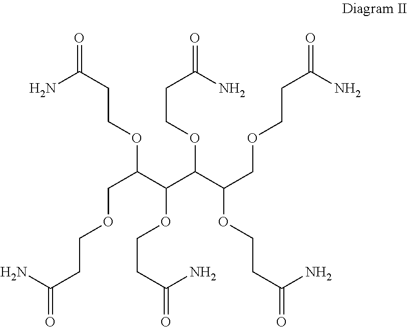 [SMILES: NC(=O)CCOCC(OCCC(N)=O)C(OCCC(N)=O)C(OCCC(N)=O)C(COCCC(N)=O)OCCC(N)=O]

Upon addition of a Cu(II) solution to the amide or carboxylic acid, the solution turns a dark olive green. Addition of ammonium hydroxide turns the solution from olive green to deep blue. To prepare wood treatment solutions free of insoluble precipitates, an ammoniacal, ethanolamine, or pyridine Cu(II) solution is added directly to the reaction solution containing amide or carboxylic acid without prior isolation of the amide or carboxylic acid. To maintain solubility, the pH of the solution is at least about 9. More suitably, the pH is between about 10 and about 11.

The resulting ammoniacal, ethanolamine, or pyridine solutions are diluted with water to known concentrations of Cu(II). Useful concentrations of copper in these solutions range from about 250 ppm to about 8000 ppm copper as determined, for example, by ion-coupled plasma determinations (ICP).

In addition, zinc cations may optionally be included in the present wood preservative compositions. Addition of Zn(II) salts to the copper complex solutions improves the uniformity of penetration of the Cu (II) wood preservative into wood. Zinc ions are used in at least a 1:1 ratio with respect to copper ions in the wood preservative solution. More suitable is a ratio that is at least about 2:1 and most suitable is a ratio of at least about 4:1. Zinc ions may be present in amounts from about 700 ppm to about 8000 ppm. Zinc ions are provided by suitable Zn(II) salts, which are any that are soluble including zinc sulfate and zinc acetate. Preferred Zn(II) salts are acetates.

### Preservative Treatment

The present wood preservative compositions may be applied on or in a cellulosic material by dipping, brushing, spraying, soaking, draw-coating, rolling, pressure-treating, or other known methods. The composition may be applied to achieve preservation of any cellulosic material, including for example wood, lumber, plywood, oriented strand board, cellulose, hemicellulose, lignin, cotton, and paper. Particularly efficacious is imbibing into wood under the standard pressure treatment process for waterborne preservative systems. A vacuum may be applied before and/or after application of the preservative composition. Removal of air from the wood under vacuum, then breaking the vacuum in the presence of preservative solution, enhances penetration of the solution into the wood.

A particularly useful treatment process for wood is as described below. Wood, either dry or fresh cut and green, is placed in a chamber that is then sealed and evacuated in a regulated cycle which is determined by the species of wood. Generally, for Southern Yellow Pine (SYP) wood, the period of evacuation is about 30 minutes, during which time the pressure within the sealed chamber is brought to a level of about two inches of mercury or less. The evacuated pressure in the chamber can vary from 0.01 to 0.5 atm. The purpose of this step is to remove air, water and volatiles from the wood. The preservative composition is then introduced into the closed chamber in an amount sufficient to immerse the wood completely without breaking the vacuum to the air. Pressurization of the vessel is then initiated and the pressure maintained at a desired level by a diaphragm or other pump for a given period of time. Initially, the pressure within the vessel will decrease as the aqueous composition within the container penetrates into the wood. The pressure can be raised to maintain a desirable level of treatment throughout the penetration period. Stabilization of the pressure within the vessel is an indication that there is no further penetration of the liquid into the wood. At this point, the pressure can be released, the wood allowed to equilibrate with the solution at atmospheric pressure, the vessel drained, and the wood removed. In this part of the process, the pressures used can be as high as 300 psig, and are generally from about 50 to 250 psig.

### Articles Incorporating Preservative Compositions

Articles of the instant invention are those having been treated with a preservative composition described herein. Following treatment of articles such as those made from or incorporating wood, lumber, plywood, oriented strand board, paper, cellulose, cotton, lignin, and hemicellulose, the ammonia in the ammoniacal solution of the preservative composition will dissipate. The copper complex is retained on and/or in the article.

The process of this invention for treating cellulosic material also includes a step of incorporating the cellulosic material, or a treated article containing the cellulosic material, such as wood, into a structure such as a house, cabin, shed, burial vault or container, or marine facility, or into a consumable device such as a piece of outdoor furniture, or a truss, wall panel, pier, sill, or piece of decking for a building.

### EXAMPLES

The advantageous attributes and effects of the processes hereof may be seen in a series of examples as described below. The embodiments of these processes on which the examples are based are representative only, and the selection of those embodiments to illustrate the invention does not indicate that materials, reactants, conditions, steps, techniques, or protocols not described in these examples are not suitable for practicing these processes, or that subject matter not described in these examples is excluded from the scope of the appended claims and equivalents thereof.

### General Procedures

All reactions and manipulations were carried out in a standard laboratory fume hood open to atmosphere. Deionized water was used where water is called for in the subsequent procedures. Sorbitol, acrylonitrile, sodium hydroxide, copper sulfate pentahydrate, zinc sulfate heptahydrate and Chromeazurol S [1667-99-8] were obtained from Sigma-Aldrich Chemical (Milwaukee, Wis.) and used as received. Concentrated ammonium hydroxide and glacial acetic acid were obtained from EM Science (Gibbstown, N.J.) and was used as received. Copper acetate monohydrate was obtained from Acros Organics (Geel, Belgium) and used as received. The pH was determined with pHydrion paper from Micro Essential Laboratory (Brooklyn, N.Y.). IR spectra were recorded using a Nicolet Magna 460 spectrometer. HPLC analyses were performed using a HP 1100C with mass spec. and UV detection. NMR spectra were obtained on a Bruker DRX Avance (500 MHz ¹H, 125 MHz ¹³C) using deuterated solvents obtained from Cambridge Isotope Laboratories. ICP measurements were performed using a Perkin Elmer 3300 RL ICP. Elemental analyses were performed by Micro-Analytical Inc, Wilmington, Del. Pressure treatment of southern yellow pine wood was performed in a high-pressure lab using stainless steel pressure vessels following the AWPA standard process (AWPA P5-01).

The meaning of abbreviations is as follows: “L” means liter(s), “mL” means milliliters, “g” means gram(s), “mmol” means millimole(s), “hr” means hour(s), “min” means minute(s), “mm” means millimeter(s), “cm” means centimeter(s), “nm” means nanometer(s), “ppm” means parts per million, “DI” is deionized, “CE-orb” is cyanoethylated sorbitol, “psi” means pounds/square inch, “NMR” means nuclear magnetic resonance, “IR” means infrared, “MHz” means megahertz, HPLC” means high performance liquid chromatography and “DS” is degree of substitution, “SD” is standard deviation, “SYP” is “southern yellow pine”, an acronym for closely related pine species that includes Pinus caribaea Morelet, Pinus elliottii Englelm., Pinus palustris P. Mill., Pinus rigida P. Mill., and Pinus taeda L.

“AWPA” is the American Wood-Preserver's Association. AWPA standards are published in the “AWPA Book of Standards”, AWPA, P.O. Box 5690, Granbury, Tex. 76049. The protocol for preservation of SYP stakes is based on AWPA Standard, Method E7-01, Sec. 4, 5, 6, and 7 and E11-97.

### Example 1

### Cyanoethylatation of Sorbitol (CE-Sorb)

A 250 mL 3-necked round-bottomed flask equipped with a mechanical stirrer, reflux condenser, nitrogen purge, dropping funnel, and thermometer in a water bath was charged with DI water (60 mL), sodium hydroxide (0.48 g), and sorbitol (32.8 g) portion wise. The solution was heated to 42° C. using the water bath with stirring to fully dissolve the sorbitol. 4-methoxyphenol (50 mg) was added directly to the solution followed by acrylonitrile (71 mL) drop-wise via a 500 mL addition funnel over a period of 2 hr. The addition was at such a rate to not exceed the solubility of acrylonitrile in the reaction. The reaction was slightly exothermic, raising the temperature to 51° C. but keeping the reaction temperature below 60° C. The reaction solution was then cooled to 42° C. and the temperature maintained for 4 hr. The solution was then allowed to cool to room temperature and the reaction was neutralized by addition of acetic acid (0.72 mL) to generate the product CE-Sorb as a 0.5 weight % solution. The IR spectrum showed a nitrile peak at 2256 cm⁻¹ and NMR and HPLC analysis indicated a DS of 4.63.

### Example 2

### Hydrolysis of CE-Sorb with Sodium Hydroxide

A 250 mL three-necked round-bottomed flask was equipped with a mechanical stirrer, condenser, and addition funnel under nitrogen. The CE-Sorb solution prepared in Example 1 was treated in the flask with a 50% by weight sodium hydroxide solution (86.4 mL) drop-wise at room temperature while stirring. The solution was heated to 50° C. for 3 hr and then cooled to room temperature. The IR spectrum of the product obtained indicated loss of most of the nitrile peak at 2250 cm⁻¹ and ¹³C NMR analysis showed loss of the nitrile carbon and appearance of the acid carbons around 180 ppm. This product is the propanoic acid ether of sorbitol.

### Example 3

### Preparation of Copper Complex of the Propanoic Acid Ether of Sorbitol and Zn Containing Wood Preservative

In a 2000 mL Erlenmeyer flask, copper sulfate pentahydrate (58.35 g) and zinc sulfate heptahydrate (134.6 g) were dissolved in DI water (1000 g) with stirring at room temperature. In a 1000 mL Erlenmeyer flask, 28% ammonium hydroxide (303.57 g) was weighed. The hydrolysis product from Example 2 (propanoic aid ether of sorbitol; 82.1 g) was added to a 10 liter carboy and placed on a top-loading balance. DI water (3000 g) was added followed by half of the ammonia solution. The metal sulfate solution was added, followed by the remainder of the ammonia solution and DI water until the total weight of the solution was 10,000 g (1485 ppm in copper, 3056 ppm zinc). The pH of the solution was about 11 as indicated by testing with pH paper.

### Example 4

### Procedure for Treatment of SYP Wood

Using 4″ (10 cm) diameter sealable stainless steel treatment cylinder and a vacuum pump as a wood impregnation system (described in AWPA Standard E7-01), 4 pre-weighed 1½″×1½″×12″ (38 cm×38 cm×30.5 cm) SYP wood stakes were treated by the full cell treatment process as follows. The treatment vessel was loaded with the 4 specimens and evacuated for 15 min under vacuum (0.532 psi). The vacuum was broken by introduction of the treatment solution of Example 3 with a copper concentration of 1485 ppm. The stakes were treated under atmospheric pressure for 15 min and then for 30 min at 150 psi. The pressure was released and the stakes were allowed to stand for 15 min. The stakes were then removed from the treater, wiped dry and re-weighed wet to ensure that the wood was penetrated with the treatment solution. The weight of copper gained was computed by multiplying the weight gain by (1485/1,000,000). The % copper in the treated “wet” stake was also computed and the data is given in Table 1.

TABLE 1
Uptake of Example 3 preservative solution.

| | | treated | | weight of | |
|---|---|---|---|---|---|
| | stake | stake | weight | copper | copper |
| stake | weight | weight | gain | gained | retention |
| number | (g) | (g) | (g) | (g) | (ppm) |
| 1 | 238.30 | 547.30 | 309.00 | 0.46 | 1926 |
| 2 | 236.90 | 547.30 | 310.40 | 0.46 | 1946 |
| 3 | 247.10 | 521.60 | 274.50 | 0.41 | 1650 |
| 4 | 245.80 | 552.60 | 306.80 | 0.46 | 1853 |

### Example 5

### Procedure for Qualitative Determination of Treatment Penetration

A cross sectional slice of one of the 1½″×1½×12″ SYP wood stakes treated in Example 4 was treated sprayed with an indicator solution containing 0.167% w/w Chromazurol S in 1.67% w/w aqueous sodium acetate solution. The wood turned a dark blue all the way through the section indicating the presence of copper and that adequate preservative penetration had occurred.

### Example 6

### Quantitative Determination of Treatment Penetration

Four stakes measuring 1.5″×1.5″×12″ (3.8 cm×3.8 cm×30.5 cm) were pressure treated with the solution prepared in Example 3. The stakes were cut at the 19″ (48.3 cm) midpoint and then duplicate cross-sections ¼″ (0.64 cm) thick were cut from the center end of the stakes to give whole sections; the whole sections were weighed. Then from the center end of the cut stakes approximately ¼ was cut away from the outside of the stakes to reveal a core section. Duplicate core sections were then cut into ¼″ thick core samples; the core samples were weighed. The samples were then dried over night at 60° C. and then ashed at 580° C. for 24 hours. The ash samples were titrated iodometrically as described in US 2007163465 to determine the amount of copper in the samples. The ratio of the relative amount of copper in the core sections compared to the relative amount of copper in the whole sections was expressed as a percent and this percent is the penetration of the preservative into wood. The preservative solution prepared as above and containing indicated a penetration of 71.8%.

TABLE 2
Penetration ratio of core vs.
full cross section of treated stakes

| | | | amount | | | |
|---|---|---|---|---|---|---|
| | | treated | of | observed | % copper | |
| | | block | thiosulfate | copper | gained/treated | |
| block | | weight | titrant | weight | stake | penetration |
| number | description | (g) | (mLs) | (g) | weight | ratio |
| 1 | full | 8.6234 | 17.70 | 0.0112 | 0.0013 | 73.34 |
| | cross | | | | | |
| | section | | | | | |
| | stake 1 | | | | | |
| 2 | core | 9.5051 | 14.30 | 0.0091 | 0.0010 | |
| | section | | | | | |
| | of | | | | | |
| | stake 1 | | | | | |
| 3 | full | 10.0690 | 20.70 | 0.0131 | 0.0013 | 70.45 |
| | cross | | | | | |
| | section | | | | | |
| | stake 2 | | | | | |
| 4 | core | 8.7698 | 12.70 | 0.0081 | 0.0009 | |
| | section | | | | | |
| | of | | | | | |
| | stake 2 | | | | | |
| | | | | | average = | 71.89 |

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

What is claimed is:

1. A process for preserving cellulosic material, or an article that comprises cellulosic material, comprising contacting the cellulosic material or article with a composition comprising:
an aqueous solution of:
(a) a copper complex of a chelating compound comprising three or more amide and/or carboxyl groups and greater than 10 carbon atoms; and
(b) ammonia, ethanolamine or pyridine in an amount sufficient to solubilize the copper complex; wherein the pH of the solution is between about 10 and about 11.

2. The process of claim 1 wherein the cellulosic material is selected from the group consisting of wood, lumber, plywood, oriented strand board, cellulose, hemicellulose, lignin, cotton and paper.

3. The process of claim 1 which comprises dipping, brushing, spraying, draw-coating, rolling, or pressure-treating the cellulosic material, or article that comprises cellulosic material, with the composition of claim 1.

4. The process of claim 1 wherein the cellulosic material, or article that comprises cellulosic material, is wood or lumber; and the process further comprises subjecting the wood or lumber to vacuum both before and after contacting the wood or lumber with the aqueous solution of claim 1.
